(19) United States
(12) Patent Application Publication
(10) Pub. No.: US 2006/0187004 A1
(43) Pub. Date: Aug. 24, 2006

(54) Method and device for reducing common more signal in power line communication system

(75) Inventors: Thomas Vollmer, Aachen (DE); Thomas Duerbaum, Baiersdorf (DE); Georg Sauerlaender, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/564,914

(22) PCT Filed: Jul. 16, 2004
(86) PCT No.: PCT/IB04/51242

§ 371 Date: Jan. 17, 2006

(30) Foreign Application Priority Data
Jul. 18, 2003 (EP) 03102230.4

(51) Int. Cl. G05B 11/01

(52) U.S. Cl. 340/310.11

(57) ABSTRACT

In a wire-bound network which comprises unshielded lines such as power supply lines, electromagnetic radiation is produced when transmitting data above the mains frequency. The device according to the invention comprises active means for reducing or eliminating the common-mode current (I-cm). To this end, these active means generate an artificial dissymmetry which is complementary to that of the network and is measured continuously or periodically.

The invention relates to wire-bound transmission systems, particularly those having an unstructured cable infrastructure such as, for example, unshielded power supply lines or communication lines. The dissymmetry of these electric lines or transmission systems leads to an undesired generation and relay of an asymmetric signal. The invention particularly relates to the reduction of such asymmetric signals and the unwanted electromagnetic radiation generated by these signals.

The method of passive filtering for suppressing the asymmetric signal is known from practice. To achieve the suppression, a common-mode filter is arranged between the connection of an apparatus generating the asymmetric signal and the input of the network. This network may be, for example, a telecommunication network or the mains. This common-mode filter protects the network from unwanted asymmetric signals.

It is known in power electronics to actively eliminate the asymmetric signal, for example, in transducer electronics for electric drives.

The active elimination of asymmetric signals is not used in conventional telecommunication connections because the conventional telecommunication network has defined parameters such as, for example, the characteristic impedance, and is symmetric, so that filters for the asymmetrical interference voltages can be optimized because they can be developed off-line. In this way, an effective suppression of asymmetric signals by means of passive elements can be achieved in an economical manner.

The stranded wires of a conventional telecommunication line are clad with lead, metal or a synthetic material when they are buried, or with aluminum when they are used in dwellings. In contrast, dissymmetric networks such as, for example, the electric installations in buildings do not have shielded lines so that asymmetrical currents lead to unwanted interference radiation. These asymmetrical currents may be considered to be capacitive substitution currents generated by each part of an electric circuit which is subjected to a voltage compensation process (represented by dV/dt). The asymmetrical currents spread from their source into their ambience (for example, the ground potential) as capacitive offset currents due to parasitic stray capacitances and return to the network cable via the lines. In this way, they constitute a large signal loop which, as an effective antenna loop, radiates unwanted electromagnetic fields. Such a source may be, for example, a Power-Line Communication (PLC) transceiver with its symmetric useful signal input coupling.

An adequately large suppression of asymmetric signals in telecommunication connections of dissymmetric networks such as, for example, the mains, which is used for power-line communication, cannot be achieved with non-adjustable passive means only, because the asymmetry of the network may be unforeseen and large, and causes useful differential-mode signals to be partly converted into unwanted asymmetric interference signals generating a high, unwanted radiation in the unshielded wires of the network.

For wire-bound broadband communication networks such as, for example, xDSL, cable TV and PLC, limit values for the unwanted radiation of these broadband networks have been defined in some countries. Adherence to these limit values is a condition for using broadband transmission systems in electric connections, particularly those using an unshielded network infrastructure.

These radiation limit values define upper limits for the transmission levels of the communication system. For example, the levels for feeding PLC signals to the network lines must not lead to radiations that affect radio reception. Principally, a signal voltage of a relatively high frequency (>50 Hz AC) is superimposed on the 230 V mains voltage in power-line communication, comprising the information to be transmitted in a suitably modulated manner. Coupling in preferably takes place between the neutral line and phase. In principle, two ranges for transmitting messages on the power supply lines are distinguished:
a) from the low-voltage transformer to the home connection,
b) within the buildings.

The field generated by symmetric signals can mostly be ignored because it rapidly decreases at a larger distance and the symmetrical values in the mains are essentially attenuated to a stronger degree than asymmetrical values.

There are parasitic stray capacitances because of the mechanical construction in the transmission system. These stray capacitances have a low impedance at relatively high frequencies and constitute a current path for high-frequency parts of the useful signal. For example, a high-frequency current may flow back via metallic housings. The parasitic elements of the individual lines or the circuit are not balanced and dissymmetry is produced, resulting in signals having different values on the lines. The resultant fields are no longer eliminated and an asymmetrical or longitudinal signal extension is obtained. The resultant asymmetrical voltage produces a current between the line and earth. The field combined with the asymmetrical current is radiated. This effect is reciprocal so that electromagnetic fields of other systems couple interference voltages into transmission systems with dissymmetry (signal-to-crosstalk). Reasons for dissymmetry are, for example:

dissymmetry of the output stage of the transmitter with respect to earth,

dissymmetrical receivers,

dissymmetrical lines with respect to earth.

The parameters influencing the dissymmetry and their random distribution along the cable are variable. Asymmetrical common-mode currents are difficult to suppress and are the main cause of unwanted radiation. The dissymmetry in the current circuit leads to an unwanted conversion of the symmetric useful signal into an asymmetrical interference voltage. Since there is usually no low-ohmic connection between signal lines and ground in symmetrical systems, the asymmetrical common-mode current flows to earth via the parasitic coupling capacitances. At small frequencies, these impedances are high-ohmic and the common-mode current and hence the radiated field are small. With an increasing frequency, the asymmetrical interference voltage also increases. To estimate the risk of asymmetrical interference voltages being produced in line systems, a measure of the dissymmetry with respect to earth is defined. Two quantities for characterizing the dissymmetry at a coupling-in location are the Transverse-Conversion-Loss (TCL) and the Longitudinal-Conversion-Loss (LCL). When measuring the LCL, an asymmetrical voltage E_{L} is fed to the mains at the measuring location and the resultant symmetrical voltage V_{T} is measured. The LCL is the logarithmic ratio of the measured symmetrical voltage V_{T} with respect to the coupled-in asymmetrical voltage E_{L} in dB in accordance with the following equation (1):

$$LCL = 20 ⨯ {log}_{10} ( \frac{{V}_{T}}{{E}_{L}} ) dB \qquad ( 1 )$$

The LCL indicates the relationship between the symmetrical and the asymmetrical voltage at the input coupling. It can thus be used for estimating the asymmetrical interference voltages to be expected when symmetrically coupling the useful signal into the mains lines.

The unwanted radiation is produced because of the conversion of symmetric signals into asymmetric signals and the resultant asymmetrical current distribution on the line. The parameter LCL describes how much of the wire-bound, symmetric useful signal is converted into unwanted asymmetric interference signals. The LCL has a temporal dependence. This dependence can be traced back to the user-dependent switching on and switching off of apparatuses, as well as on the internal mode of operation of apparatuses.

When measuring the TCL, the voltage U_{L} is measured on a series resistor whose value is a quarter of the value of the impedance of the test object. This resistor is arranged between the central point of the signal input coupling and earth. The voltage U_{L} is measured when supplying a symmetrical voltage U_{T}. The TCL is the logarithmic ratio of the measured, supplied voltage U_{T} with respect to the measured asymmetrical voltage U_{L} in dB in accordance with the following equation (2):

$$TCL = 20 ⨯ log ( \frac{{U}_{T}}{{U}_{L}} ) dB \qquad ( 2 )$$

It is an object of the invention to provide a device which prevents or reduces asymmetric interference signals and hence reduces the electromagnetic radiation of a wire-bound network, for example, consisting of asymmetric and unshielded lines. It is a further object of the invention to provide a method of reducing the electromagnetic radiation of a wire-bound transmission system having unshielded lines.

According to the invention, the object is achieved by a device comprising means for measuring the dissymmetry of the network at a supply point, as well as means for actively eliminating or reducing the asymmetric signal.

In undefined networks, such as the mains, the LCL and the TCL change with time and with the supply location. A filtering system with a fixed adjustment cannot react to these changes and can thus neither react to changing dissymmetry properties of electromagnetic radiations. The invention therefore proposes an active elimination or at least a reduction of the asymmetric signal with appropriate means.

The means for actively eliminating or reducing the asymmetric signal comprise a control circuit which influences the symmetry of the supplied useful signal to such an extent that it changes in dependence upon the currently measured dissymmetry of the network. For use in a network with dissymmetry and unshielded lines, only the use of passive filters for suppressing the asymmetric signal is known. It is true that, in power electronics, the use of active elements is known, but this is not the case for transmission systems. The invention is therefore based on the recognition that, in a network having an unforeseeable behavior, the asymmetric signal can be reduced with active and adaptive means to a further extent than with passive means, and may even be eliminated. In this context, active is understood to mean that the behavior of the means is changeable.

In accordance with an embodiment of the invention, the control circuit comprises at least the following elements:

a measuring sensor for the asymmetrical common-mode current which flows between the phase and neutral lines and earth or the protective line, and

a summing point for comparing the measured values of the asymmetrical common-mode current with the nominal value for the asymmetrical current.

The nominal value is preferably 0 A. The control circuit operates continuously or periodically so that the differential current generated by the comparator varies with time.

The means for actively eliminating or reducing the asymmetric signal comprise a controller which is fed with the actual transmission signal and the output signal of the comparator and computes two output signals in dependence upon the two input signals. The two output signals represent a division of the transmission signal. The division is obtained because the transmission signal is divided on two mains coupling devices, one of which is arranged between phase and earth and the other between the neutral line and earth.

The device according to the invention is suitable for generating two output signals having an artificial dissymmetry. The artificial dissymmetry is chosen to be such that it substantially reduces, or also eliminates the common-mode current when it is superimposed on the real dissymmetry of the network.

The device according to the invention is suitable for wire-bound transmission systems having dissymmetry and unshielded lines consisting of, for example, communication lines, electric installation lines or power supply lines.

The object of the invention is also achieved by means of a method of reducing the electromagnetic radiation of a wire-bound transmission system with dissymmetry and unshielded lines, which radiation is produced when data having a frequency above the mains frequency are transmitted, in which the current dissymmetry of the network is measured and two output signals having an artificial dissymmetry which is complementary to that of the network are generated from the transmission signal. In this respect, artificial is understood to mean that the actual symmetric transmission signal is changed in such a way that it is asymmetric. “Complementary” is understood to mean that the dissymmetry of the network, on the one hand, and the artificially generated dissymmetry, on the other hand, is canceled out when they are mixed.

In the method according to the invention, the secondary side of a first mains coupling device conveys a first mains coupling voltage which corresponds to the differential-mode voltage between the phase and the neutral line, multiplied by the factor (a), and the secondary side of a second mains coupling device conveys a second mains coupling voltage which corresponds to the differential-mode voltage between the phase and the neutral line, multiplied by the factor (1−a). When the value for a is unequal to 0.5, both secondary voltages and mains coupling voltages are unequal, i.e. dissymmetrical.

In accordance with an embodiment of the invention, the method comprises the steps of:
measuring the current dissymmetry of the network,
comparing the measured dissymmetry with a nominal value,
supplying the result of the comparison to a controller,
computing two output signals of the controller in dependence upon the result of the comparison and a supplied transmission signal,
controlling a first adjusting element of a first transmitter in accordance with the first output signal,
controlling the second adjusting element of a second transmitter in accordance with the second output signal, and
coupling the divided differential-mode voltage generated by the control into the network.

The current dissymmetry of the network may be measured, for example, by an induced voltage in a current-measuring sensor or by determining the LCL or TCL. The comparison of the measured dissymmetry with a nominal value, for example, zero, can be made at a summing point. The two output signals of the control apparatus are the values for the adjusting elements of the two transmitters. Each transmitter is connected to a mains coupling device.

The device according to the invention may be used, for example, for a transmission modem.

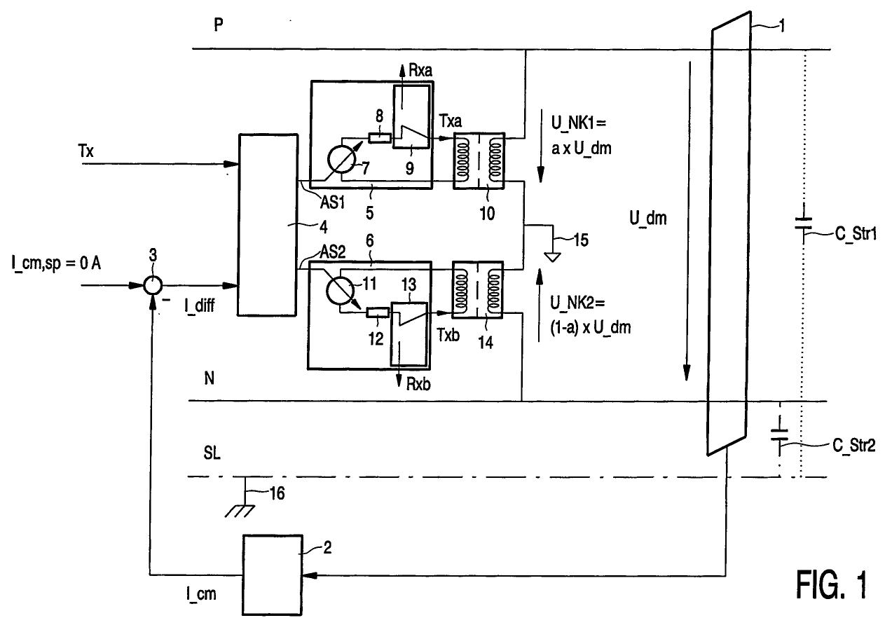

The invention will hereinafter be described, by way of example, with reference to FIG. 1 which is a schematic block diagram of an embodiment.

FIG. 1 is a schematic block diagram of an embodiment of the device according to the invention for reducing the electromagnetic radiation of a wire-bound transmission system with dissymmetry and unshielded lines. The unwanted asymmetrical common-mode current I_cm on the phase P and the neutral line N induces a voltage in the current-measuring sensor 1. The output apparatus 2 visualizes the actual value of the common-mode current I_cm by proportional transformation of the value for the induced voltage, detected by the current-measuring sensor 1. The current value of the common-mode current I_cm is subtracted from the nominal value I_cm, sp at the summing point 3. The nominal value of the asymmetrical current is preferably 0 A. The output signal at the summing point 3, the differential value I_diff, is applied to a controller 4. A second input value of the controller 4 is the transmission signal Tx. Based on the two input quantities, transmission signal Tx and current difference I_diff, the controller 4 computes two output signals controlling the two transmitters 5 and 6. The first transmitter 5 consists of a first adjusting element 7, a first impedance 8 and a first switching means 9 for switching between the first transmission signal Txa and the first reception signal Rxa. The first transmission signal Txa is supplied to the network via the first mains coupling device 10 and with the switching means 9 closed. The secondary side of the first mains coupling device 10 conveys a first mains coupling voltage U_NK1 which corresponds to the differential-mode voltage U_dm, multiplied by the factor a, in accordance with the following equation (3):
U_{—}NK1=a×U_{—}dm (3)

The second transmitter 6 consists of a second adjusting element 11, a second impedance 12 and a second switching means 13 for switching between the second transmission signal Txb and the second reception signal Rxb. The second transmission signal Txb is supplied to the network via the second mains coupling device 14, with the switching means 13 closed. The secondary side of the second mains coupling device 14 conveys a second mains coupling voltage U_NK2 which corresponds to the differential-mode voltage U_dm, multiplied by the factor (1−a), in accordance with the following equation (4)
U_{—}NK2=−(1−a)×U_{—}dm (4)

The opposite outputs of the secondary sides of the mains coupling devices 10 and 14 are connected to an earth or ground terminal 15. The two parasitic stray capacitances C_Str1 between the phase P and the protective line SL, as well as the second parasitic stray capacitance C_Str2 produced between the neutral line N and the protective line SL are shown in dotted lines. Both stray capacitances C_Str1 and C_Str2 are connected to earth via the ground terminal 16 of the protective line SL.

The differential-mode voltage U_dm between the phase P and the neutral line N is preferably split up dissymmetrically between the two secondary sides of the first and the second mains coupling devices 10 and 12, i.e. a≠0.5.

The control apparatus 4 controls the division, i.e. the value a, by changing the output signals AS1 and AS2. To this end, the dissymmetry of the network is measured at the input point of the device and expressed, for example, by the common-mode current I_cm. The measurement is performed, for example, by applying a defined, symmetric comparison signal before the envisaged data transmission starts and by simultaneous observation of the amplitude and the phase of the resultant, unwanted and asymmetric signals. Based on the observed dissymmetry, the control apparatus 4 imparts an artificial dissymmetry on the transmission signal. The artificial dissymmetry is quasi-complementary to the dissymmetry of the network, measured at the input point. The artificial dissymmetry as well as the current dissymmetry of the network ideally cancel each other, but at least reduce the electromagnetic radiation.

In accordance with a variant of the invention, the transmission signal is adapted to the dissymmetry of the network periodically and with equal intervals. In accordance with a further variant of the invention, the control circuit is controlled continuously.

In summary, the device according to the invention comprises active means which reduce or eliminate the common-mode current I_cm so as to counteract electromagnetic radiation produced in a wire-bound network built up of unshielded lines such as power supply lines. To this end, these active means generate an artificial dissymmetry which is complementary to that of the network and is measured continuously or periodically.

1. A device for reducing the electromagnetic radiation of a wire-bound transmission system having dissymmetry and unshielded lines, provided for broadband communication and having a transmission path for a transmission signal, the device comprising means for measuring the dissymmetry of the network at a supply point, characterized in that the device comprises means for actively eliminating or reducing the asymmetric signal.

2. A device as claimed in claim 1, characterized in that the means for actively eliminating or reducing the asymmetric signal comprise a control circuit for changing the currently measured dissymmetry of the network.

3. A device as claimed in claim 1, characterized in that the control circuit comprises at least:
a measuring head (1) for the asymmetrical common-mode current (I_cm) which flows between the phase (P) and neutral lines (N) and earth or the protective line (SL), and
a summing point (3) for comparing the measured values of the asymmetrical common-mode current (I_cm) with the nominal value for the asymmetrical current (I_cm, sp).

4. A device as claimed in claim 1, characterized in that the means for actively eliminating or reducing the asymmetric signal comprise a controller (4) which is fed with the current transmission signal (Tx) and the output signal (I_diff) of the summing point (3) and computes two output signals (AS1, AS2) in dependence upon the input signals (Tx, I_diff).

5. A device as claimed in claim 1, characterized in that it is suitable for generating two output signals (AS1, AS2) having an artificial dissymmetry.

6. A device as claimed in claim 1, characterized in that the wire-bound transmission system is constructed with unshielded lines consisting of communication lines, electric installation lines or power supply lines.

7. A method of reducing the electromagnetic radiation of a wire-bound transmission system having dissymmetry and unshielded lines, which radiation is produced when data having a frequency above the mains frequency are transmitted, characterized in that, in the method, the current dissymmetry of the network is measured and two output signals (AS1, AS2) having an artificial dissymmetry which is complementary to that of the network are generated from the transmission signal (Tx).

8. A method as claimed in claim 7, characterized in that the secondary side of a first mains coupling device (10) conveys a first mains coupling voltage (U_NK1) which corresponds to the differential-mode voltage (U_dm) between the phase (P) and the neutral line (N), multiplied by the factor (a), and in that the secondary side of a second mains coupling device conveys a second mains coupling voltage (U_NK2) which corresponds to the differential-mode voltage (U_dm) between the phase (P) and the neutral line (N), multiplied by the factor (1−a).

9. A method as claimed in claim 7, characterized in that it comprises the steps of
measuring the current dissymmetry of the network,
comparing the measured dissymmetry with a nominal value,
supplying the result of the comparison to a controller (4),
computing two output signals (AS1, AS2) of the controller (4) in dependence upon the result of the comparison (I_diff) and a supplied transmission signal (Tx),
controlling a first adjusting element (7) of a first transmitter (5) in accordance with the first output signal (AS1),
controlling the second adjusting element (11) of a second transmitter (6) in accordance with the second output signal (AS2), and
coupling the divided differential-mode voltage (U_dm) generated by the control into the network.

10. Use of a device as claimed in claim 1 for a transmission modem.
